(19) United States
(12) Patent Application Publication
(10) Pub. No.: US 2009/0199820 A1
(43) Pub. Date: Aug. 13, 2009

(54) PRESSURE CONTROL VALVE WITH LIMP-HOME AND VENTILATION FUNCTION

(75) Inventor: Gerhard Geyer, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 12/299,378

(22) PCT Filed: Mar. 12, 2007
(86) PCT No.: PCT/EP2007/052264

§ 371 Date: Nov. 3, 2008

(30) Foreign Application Priority Data
May 4, 2006 (DE) 10 2006 020 692.4

(51) Int. Cl. F02M 69/54; F02M 55/02

(52) U.S. Cl. 123/447; 123/458

(57) ABSTRACT

The invention relates to a fuel injection system for internal combustion engines, having a high-pressure accumulator which has a cavity under system pressure. Provided to the high-pressure accumulator is a pressure control valve that can be actuated electromagnetically. The cavity can be connected by the latter to a low-pressure side of the high-pressure accumulator. Arranged between the cavity and the low-pressure side of the high-pressure accumulator is a check valve which enables the high-pressure accumulator to be filled from the low-pressure side to the system pressure side.

### PRIOR ART

The publication “Dieselmotor-Management” [Diesel Engine Management] 2^{nd} updated and expanded edition, Viehweg 1998, Braunschweig; Wiesbaden, ISBN 3-528-03873-X, p. 270, FIG. 9 has disclosed a pressure control valve. The pressure control valve is used in a high pressure pump, see p. 267, FIG. 7 of the same publication. The pressure control valve includes a ball valve, which contains a ball-shaped closure member. The pressure control valve contains an armature that is acted on at one end by a compression spring and at the other, is situated opposite an electromagnet. Fuel circulates around the armature of the pressure control valve in order to lubricate and cool it.

If the pressure control valve is not activated, then the high pressure that is present in the high pressure accumulator or at the outlet of the high pressure pump is present at the pressure control valve via the high pressure inlet. Since the electromagnet does not exert any force when it is without current the force of the high pressure predominates over the spring force of a compression spring so that the pressure control valve opens and, depending on the required quantity of fuel, remains open for a longer or shorter period of time.

If, however, the pressure control valve is activated, i.e. the electromagnet is supplied with current, then the pressure in the high pressure circuit is increased. To this end, in addition to the force exerted by the compression spring, a magnetic force is produced. The pressure control valve is closed until an equilibrium of forces exists between the high pressure force on the one hand and the spring force and magnetic force on the other. The magnetic force of the electromagnet is proportional to the excitation current I of the magnet coil inside the pressure control valve. The excitation current I can be varied by means of cyclic control (pulse-with modulation).

According to the above-mentioned publication, page 270, FIG. 7, the pressure control valve is, for example, screwed into the high pressure pump. In this case, the problem arises that the required precise characteristic curve p=f(I), where I is the excitation current of the electromagnet for \dot{q}=const. The air gap L is set during the disassembly of the pressure control valve into a receiving component, in this case for example, a high pressure pump. The appearance of the characteristic curve of the pressure control valve p=f(I) depends on the air gap L. The required tolerance of the above-mentioned characteristic curve p=f(I) of the pressure control valve is adjusted at an inspection point that is defined by a selected value for the excitation current I of the coil of the electromagnet. A pressure tolerance ±□p of the pressure control valve is determined at this inspection point. The smaller this tolerance turns out to be, the better the regulation quality can be achieved with regard to the actuation behavior of the pressure control valve and thus the more precisely the pressure control valve reacts to pressure fluctuations between the high pressure side and the low pressure side. Since the air gap L depends on the installation quality, and in prior methods, can only be adjusted with a great deal of effort, the pressure tolerance ±□p occurring at the inspection point depends to a significant degree on the level of quality of the installation of the pressure control valve in a high pressure pump or other component subjected to high pressure.

DE 102 14 084 A1 relates to an adjustable pressure control valve for fuel injection systems. The fuel injection system includes a high pressure accumulator that is acted on with highly pressurized fuel by means of a high pressure delivery unit and supplies fuel to the fuel injectors. The high pressure delivery unit is associated with a pressure control valve that is situated between a high pressure side and a low pressure side and includes a valve element that can be triggered by means of an electrical actuator. The pressure control valve includes a housing component that contains a deformable region by means of which it is possible to adjust a gap L between the surfaces of an electrically triggerable actuating device during the installation of the pressure control valve in a receiving component.

In high pressure injection systems, e.g. a common rail system for motor vehicles, in connection with the dual actuator concept, a pressure control valve is used, whose purpose is to permit the dynamic pressure decrease in leakage-free injectors, e.g. fuel injectors that are triggered by means of a piezoelectric actuator, in the lower speed and load range of the internal combustion engine, a very good pressure regulation at low pressures. It is not possible to achieve this with the required level of quality by means of regulating actions that solely affect the intake side of a high pressure delivery unit. The above-mentioned leakage-free injectors have not previously been used in commercial vehicles, which means that the pressure decrease in this practical application occurs only via fuel injector leakage inherent to the system. A pressure control valve known from the prior art (FIG. 1) has the property of being completely open when it is without current in order to assure the filling of the high pressure accumulator even after the internal combustion engine has been switched off and to thus assure a rapid restarting of the engine. For commercial vehicles, such a design is not acceptable to the client because, for example, when an electrical malfunction such as a cable failure occurs, this fuel injection system becomes depressurized, causing the engine to immediately die. This is not acceptable due to the high demand for vehicle availability.

### DISCLOSURE OF THE INVENTION

In view of the technical problem demonstrated above and the designs known from the prior art, the object of the present invention is to produce a pressure control valve for use in high pressure accumulator injection systems, in particular for commercial vehicles, that assures a limp-home function.

According to the invention, this object is attained in that in the pressure control valve or in the high pressure accumulator (common rail), a check valve is used, whose opening direction is oriented from the low pressure side toward the high pressure side and permits a connection of the low pressure fuel return to the high pressure region of the high pressure accumulator when this check valve is opened by the negative pressure that occurs due to the cooling of the high pressure accumulator, thus assuring the filling of the high pressure accumulator. This assures that there is always a complete filling of the high pressure accumulator. When high pressure, i.e. system pressure, is built up in the high pressure accumulator by the high pressure delivery unit, e.g. the high pressure fuel pump, then the check valve closes the high pressure region off from the low pressure return.

The check valve that closes the low pressure side off from the high pressure side of the high pressure accumulator can be integrated into the wall of the high pressure accumulator (common rail) or can also be accommodated in a base plate of the pressure control valve. The decisive factor for the installation position of the check valve is the fact that the check valve permits fuel to flow through the high pressure side and low pressure side of the high pressure accumulator in one direction, i.e. from the low pressure side in the direction toward the high pressure side, thus assuring a constant filling of the cavity of the high pressure fuel accumulator (common rail). By contrast with the design known from the prior art, in the pressure control valve proposed according to the invention, the effective directions of the electromagnet and closing spring are reversed. This means that the electromagnet of the pressure control valve proposed according to the invention exerts a force in the opening direction in relation to a closure element that closes the high pressure accumulator at one end, while a closing spring that acts on an armature pin, which in turn acts on the closure element, acts in the closing direction in relation to the closure element. When the high pressure accumulator cools, a negative pressure is produced in it, as a result of which the valve opens and a replenishing flow of fuel travels out of the low pressure region and into the high pressure accumulator. Consequently, when the system is restarted, a complete filling of the high pressure accumulator is always assured, thus enabling a quicker start.

### DRAWINGS

The invention will be explained in greater detail below in conjunction with the drawings.

FIG. 1 shows a pressure control valve known from the prior art in which the electromagnet acts in the closing direction and a spring element acts in the opening direction,

FIG. 2 is a schematic diagram of the pressure control valve show in FIG. 1,

FIG. 3 shows a pressure control valve with reversed effective directions of a magnetic force generated by the electromagnet coil and a closing force exerted by a closing spring,

FIG. 4 is a schematic diagram of the pressure control valve proposed according to the invention, with an electromagnet acting in the opening direction and a closing spring acting in the closing direction and a schematically depicted installation position of a check valve,

FIG. 5 shows a section through the pressure control valve proposed according to the invention shown in the schematic diagram in FIG. 4, and

FIG. 5.1 shows a valve, which is integrated into a seat ring and is for the filling of the high pressure accumulator.

### EMBODIMENT VARIANTS

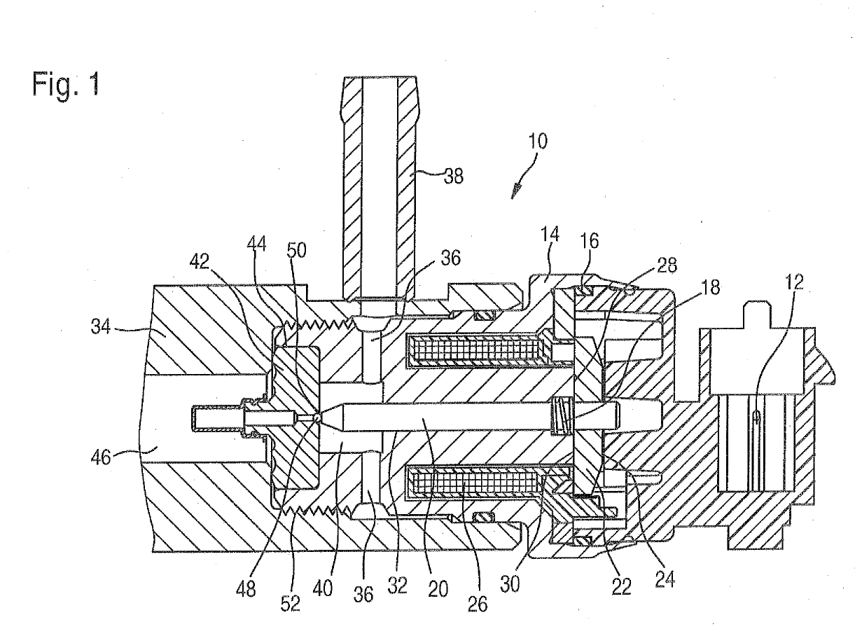

FIG. 1 shows a pressure control valve known from the prior art in which an electromagnet acts in the closing direction in relation to a closure element and a compression spring, which acts on the armature of the pressure control valve, acts in the opening direction in relation to on the closure element.

FIG. 1 shows a pressure control valve 10, which has a magnet coil 26 that can be supplied with current via an electrical connection 12 equipped with a plug connection. The pressure control valve 10 according to the depiction in FIG. 1 includes a housing 14 that is sealed in relation to the electrical connection 12 by means of a sealing ring 16. The housing 14 of the pressure control valve 10 contains a compression spring 18, which encompasses an armature pin 20 and acts on an armature plate 22 in the opening direction. On the opposite side of the armature plate 22, the plug connector 12 is equipped with a stop 24. The housing 14 of the pressure control valve 10 according to the depiction shown in FIG. 1 accommodates the above-mentioned magnet coil 26. An end surface 28 of the armature plate 22 and an end surface 30 of the housing 14 are oriented toward each other; the distance between these two end surfaces 28, 30 defines the stroke path of the armature pin 20 when the magnet coil 26 is supplied with current.

The armature pin 20 is able to slide in an armature bore 32 of the housing 14 of the pressure control valve 10.

The housing 14 of the pressure control valve 10 is screw-connected to a high pressure accumulator 34 by means of a thread 52. In the housing 14 of the pressure control valve 10, low pressure bores 36 are provided on both sides of a cavity 40 and feed into a return 38 via which the fuel on the low pressure side flows back into a tank of a motor vehicle. A recess 44 inside the housing 14 accommodates a seat ring 42. The seat ring 42 has a seat 50 embodied in it for a closure element 48 that is embodied as ball-shaped in the depiction according to FIG. 1. The high pressure accumulator 34 (common rail) has a tubular cavity 46 inside it in which fuel is stored at system pressure. The system pressure of the fuel is built up by means of a high pressure delivery unit that acts on the high pressure accumulator 34, for example a high pressure pump that is not shown in the depiction in FIG. 1, but is connected to the high pressure accumulator 34.

In the pressure control valve 10 shown in FIG. 1, in the event of a malfunction such as a cable failure at the electrical connection 12, the fuel stored in the cavity 46 of the high pressure accumulator 34 loses the pressure required for the injection. This is caused by the fact that in the event of a cutoff of power to the magnet coil 26, the armature plate 22 does not act in the closing direction on the armature pin 20 and therefore on the closure element 48 embodied in the form of a ball here, but instead, the compression spring 18 moves the armature plate 22 against the stop 24 on the electrical plug connector 12 so that the closure element 48 opens and the pressure stored in the cavity 46 of the high pressure accumulator 34 is discharged into the low pressure cavity 40 and from there, flows through the low pressure bores 36 into the return 38 to the tank of the vehicle. Consequently, with the embodiment variant of the pressure control valve 10 shown in FIG. 1, in the event of a malfunction such as a cable failure, the entire fuel injection system can become depressurized, causing the internal combustion engine to immediately die, which is unacceptable in commercial vehicle applications for availability reasons.

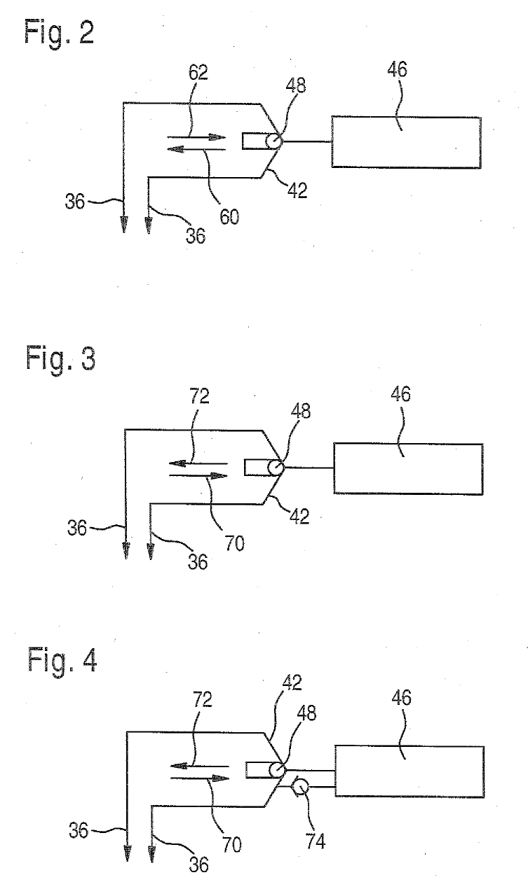

FIG. 2 schematically depicts the effective directions of the electromagnet and the compression spring in the exemplary embodiment according to FIG. 1.

FIG. 2 shows that the magnet coil 26 shown in FIG. 1 acts on the armature pin 20 in a first effective direction 62, which moves the closure element 48 into the seat ring 42. The compression spring 18 shown in the exemplary embodiment according to FIG. 1 acts in a first effective direction 60. If the magnet coil 26 is without current, then the first effective direction 62 of the magnetic force is eliminated and the closure element 48 opens as a result of the spring force of the valve spring of the compression spring 18 acting in the first effective direction 60 so that the chamber 46 in which fuel is stored at system pressure is depressurized via the low pressure bores 36 since the closure element 48 is open.

FIG. 3 is a schematic depiction of a pressure control valve in which the effective directions of the electromagnet and the valve spring are reversed in comparison to the depiction according to FIG. 2.

According to the schematic depiction shown in FIG. 3, the magnet coil 26 according to the depiction in FIG. 1 acts in a second effective direction 72, i.e. in the opening direction in relation to the closure element 48. By contrast the compression spring 18 acts in the closing direction in relation to the closure element 48 so that in the event of a cutoff of power to the magnet coil 26 (see depiction in FIG. 1), the fuel volume stored in the cavity 46 of the high pressure accumulator 34 is prevented from escaping in an uncontrolled fashion into the low pressure bores 36 and therefore into the return 38 to the tank of the vehicle. A refilling of the cavity 46, however, is not possible with the thematic fundamental structure shown in FIG. 3.

FIG. 4 is a schematic depiction of the pressure control valve proposed according to the invention.

FIG. 4 shows that the into the magnet coil 26 of a pressure control valve 80 with reversed effective directions that will be described in greater detail below, has an electromagnet 26 that acts in the second effective direction 72, i.e. in the opening direction in relation to the closure element 48. By contrast, a closing spring that will be described in greater detail below exerts a closing force oriented in the second effective direction 70 in the depiction according to FIG. 4, i.e. acts on the closure element 48 in the closing direction and therefore moves it into the seat in the seat ring 42. This assures that in the event of a cutoff of power to the magnet coil 26, the fuel volume stored at system pressure in the cavity 46 of the high pressure accumulator 34 does not flow in an uncontrolled fashion back into the low pressure bores 36 and therefore into the return 38 to the tank of the vehicle. A check valve 74 is integrated into the system between the cavity 46 of the high pressure accumulator 34 and the low pressure side—indicated here by the low pressure bores 36. The check valve has an opening direction that is oriented from the low pressure region toward the high pressure region, i.e. toward the cavity 46 in the high pressure accumulator 34. Consequently, the check valve 74 is closed in the direction toward the low pressure side when a pressure is exerted on the cavity 46 of the high pressure accumulator 34, whereas with a cooling of the high pressure accumulator 34 and of the fuel volume stored in the cavity 46 when the internal combustion engine is switched off and with the negative pressure caused by the accompanying volume decrease of the fuel, a flow of fuel from the low pressure side into the cavity 46 is permitted via the check valve 74.

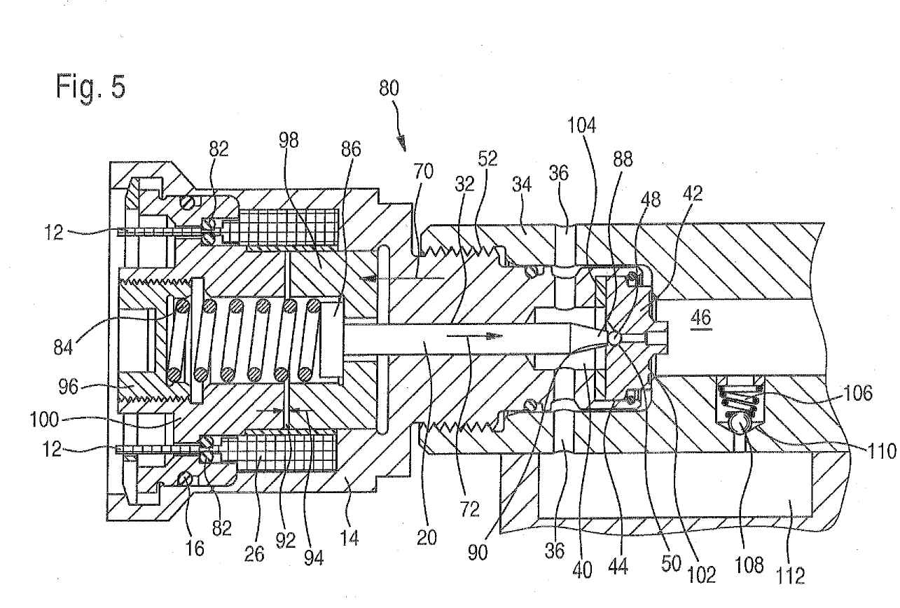

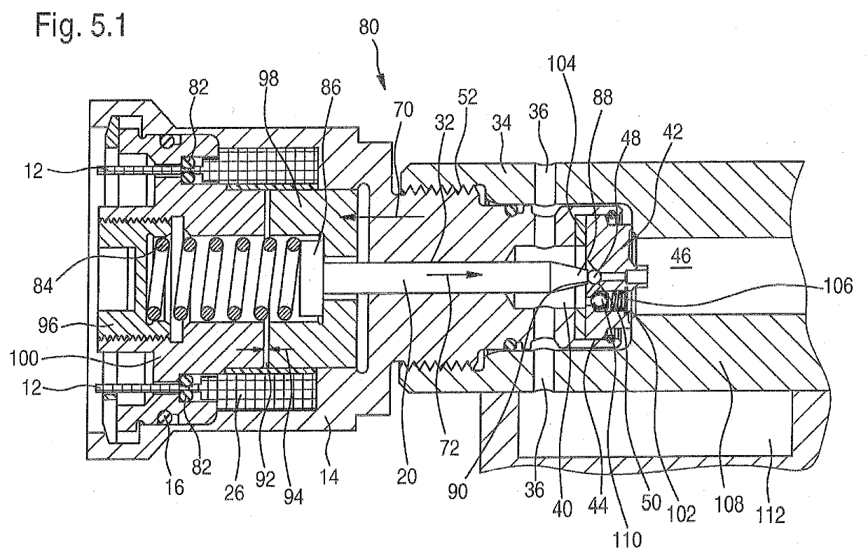

FIG. 5 shows a detailed depiction of a section through the pressure control valve proposed according to the invention, with reversed effective directions of a closing spring and an electromagnet.

A pressure control valve 80 shown in FIG. 5 is screw-connected by means of the thread of 52 to the high pressure accumulator 34 (common rail) that is embodied as tubular in this instance. The housing 14 of the pressure control valve 80 with reversed effective directions contains the magnet coil 26, whose electrical connections 12 are each encompassed by a respective sealing ring 82. The housing 14 of the pressure control valve 80 also contains an armature pin receptacle 98, which encompasses an armature pin plate 86, as well as a closing spring receptacle 100 that encompasses a closing spring 84. The armature pin receptacle 98 and the closing spring receptacle 100 are separated from each other by a gap 92. A gap distance 94 between the reciprocally opposing end surfaces of the armature pin receptacle 98 and the closing spring receptacle 100 is labeled with the reference numeral 94. The armature pin 20 is guided in the armature bore 32 in the housing 14 and has the above-mentioned armature pin plate 86 at one end and at the other end, has a flattened region 90 on its end oriented toward the seat ring 42. The flattened region 90 is oriented toward the closure element 48, which is depicted as ball-shaped in FIG. 5. Inside the recess 44, the housing 14 of the pressure control valve 80 with the reversed effective directions according to the depiction in FIG. 5 contains the seat ring 42, in which the seat 50 is formed by the ball-shaped closure element 48. A high pressure side of the seat ring 42 is labeled with the reference numeral 102 and a low pressure side of the seat ring 42 that is oriented toward the cavity 40 in the housing 14 is labeled with the reference numeral 104.

The closing spring 84, which is encompassed by the closing spring receptacle 100 and is also partially encompassed by the armature pin receptacle 98, is prestressed by means of a prestressing element 96. By means of this prestressing element 96 against which one end of the closing spring 84 rests, it is possible to adjust the spring force, which is exerted by the closing spring 84 and acts on the armature pin plate 86 of the armature pin 20 in the second effective direction 70. The other end of the closing spring 84 rests against the armature pin plate 86 of the armature pin 20.

In the depiction according to FIG. 5, the check valve 74 is situated in the wall of the high pressure accumulator 34 (common rail), which is embodied in tubular form. The check valve 74 has a closure element 108, which is embodied in the form of a ball here and which is acted on by means of the spring 106. As shown in FIG. 5, the spring 106 can be fixed in place by a press-fitted ring so that the spring 106 only has to exert slight spring forces. FIG. 5.1 shows an embodiment variant of the design proposed according to the invention in which the components of the valve 74 embodied in the form of a check valve situated between the high pressure region and the low pressure region, i.e. the ball-shaped closure element 108 and the spring 106 affixed by means of a ring, are embodied as integrated into the seat ring 42 and likewise provide a possibility for filling the cavity 46. The check valve 74 in the wall of the high pressure accumulator 34 (common rail) prevents the flow of fuel from the cavity 46 of the high pressure accumulator 34 at system pressure in the direction of a cavity 112 on the low pressure side since the closure element 108 embodied in the form of a ball in the depiction according to FIG. 5 is pressed into its seat 110 in the wall of the high pressure accumulator 34. On the other hand, the check valve 74 achieves the fact that in the event of cooling fuel and a switched off internal combustion engine, by means of the low pressure cavity 112, a filling of the cavity 46—which in this instance is not acted on with system pressure—takes place from the low pressure cavity 112 via the check valve 74. The check valve 74 is opened by the negative pressure that occurs in the cavity 46 of the high pressure accumulator 34 when the fuel contained therein cools, as a result of which it is possible for the cavity 46 of the high pressure accumulator 34 to be filled from the low pressure cavity 112. During the starting of the internal combustion engine, if system pressure is built up in the cavity 46 by the high pressure pump driven during the cranking of the engine, then the check valve 74 closes the cavity 46 off from the low pressure cavity 112 in that the closure element 108 of the check valve 74, which element is embodied as ball-shaped here, is pressed into its seat 110 in the wall of the high pressure accumulator 34 (common rail).

In the depiction according to FIG. 5, the check valve 74 is embodied in the wall of the high pressure accumulator 34 (common rail). Alternatively, it is also possible to accommodate the check valve 74 depicted in FIG. 5 in the base plate 42 of the pressure control valve 80 with reversed effective directions. As regards the installation location of the check valve 74, the sole deciding factor is that it disconnects the system pressure-carrying cavity 46 of the high pressure accumulator 34 from the low pressure side of the pressure control valve 80 with reversed effective directions such that an opening direction of the check valve 74 is produced from the low pressure side to the high pressure side.

The pressure control valve 80 with reversed effective directions shown in FIG. 5 is advantageously used in motor vehicle or commercial vehicle applications in which leakage-free fuel injectors are used, which are triggered for example by means of a piezoelectric actuator. In the event of a cutoff of power to the magnet coil 26 of the pressure control valve 80 with reversed effective directions shown in FIG. 5, which can, for example, occur due to a cable failure, the closing spring 84, which acts in the second effective direction 70 on the ball-shaped closure element 48, then assures that the fuel stored in the cavity 46 does not flow out via the open closure element 48 into the low pressure cavity 40 in the housing 14 and from there, via the low pressure bores 36 into the low pressure return 38 depicted in FIG. 1. As a result, in the event of a cable failure, fuel remains stored in the cavity 46 at system pressure, thus retaining a limp-home function of the with a high pressure accumulator injection system equipped with the pressure control valve 80 proposed according to the invention.

On the one hand, the closing spring 84 acts on the armature pin 20 in the second effective direction 70 so that the closure element 48 remains in its seat 50 in the seat ring 42. In addition, either the check valve 74 that is accommodated in the wall of the high pressure accumulator 34 (common rail) or the valve 74 that is accommodated in a base plate of the pressure control valve 80 with reversed effective directions assures that in the event of a cutoff of the power to the magnet coil 26, a replenishing flow of fuel can travel from the low pressure region 112 into the cavity 46 of the high pressure accumulator 34 (common rail) if the fuel volume decreases, e.g. due to cooling, thereby resulting in a negative pressure within the volume of the high pressure accumulator.

1-9. (canceled)

10. A fuel injection system for internal combustion engines, comprising:
a high pressure accumulator equipped with a cavity at system pressure;
an electromagnetically actuatable pressure control valve associated with the high pressure accumulator, the pressure control valve connecting the cavity to a low pressure side of the high pressure accumulator; and
a valve disposed between the cavity and the low pressure side of the high pressure accumulator, the valve permitting the filling of the high pressure accumulator from the low pressure side to a system pressure side.

11. The fuel injection system as recited in claim 10, wherein a magnet coil of the pressure control valve produces a force acting in an opening direction in relation to a closure element.

12. The fuel injection system as recited in claim 10, wherein a closing spring of the pressure control valve produces a force acting in a closing direction in relation to a closure element.

13. The fuel injection system as recited in claim 12, wherein the force of the closing spring acting in the closing direction is adjusted by means of a prestressing element that is screwed into the housing.

14. The fuel injection system as recited in claim 10, wherein the valve is embodied in the form of a check valve.

15. The fuel injection system as recited in claim 10, wherein the valve is either accommodated in a wall of the high pressure accumulator or is embodied in a base plate of the pressure control valve.

16. The fuel injection system as recited in claim 12, wherein the closing spring is encompassed by an armature pin receptacle that is spaced apart from a closing spring receptacle by a gap distance.

17. The fuel injection system as recited in claim 16, wherein the gap distance between the armature pin receptacle and the closing spring receptacle defines a stroke path of an armature pin in a housing of the pressure control valve.

18. The fuel injection system as recited in claim 10, wherein when the internal combustion engine is switched off and a negative pressure builds up in the cavity due to cooling fuel, the cavity of the high pressure accumulator is filled from the low pressure side via the valve and then remains filled.
